(19) United States
(12) Patent Application Publication
(10) Pub. No.: US 2025/0149590 A1
(43) Pub. Date: May 8, 2025

(54) NONAQUEOUS ELECTROLYTE SECONDARY BATTERY POSITIVE ELECTRODE AND NONAQUEOUS ELECTROLYTE SECONDARY BATTERY

(71) Applicant: Panasonic Energy Co., Ltd., Moriguchi-shi, Osaka (JP)

(72) Inventors: Hideaki Fujiwake, Osaka (JP); Takeshi Chiba, Osaka (JP); Shun Nomura, Osaka (JP)

(73) Assignee: Panasonic Energy Co., Ltd., Moriguchi-shi, Osaka (JP)

(21) Appl. No.: 18/838,106

(22) PCT Filed: Feb. 21, 2023
(86) PCT No.: PCT/JP2023/006280

§ 371 Date: Aug. 13, 2024

(30) Foreign Application Priority Data
Feb. 21, 2022 (JP) 2022-024626

(51) Int. Cl. H01M 4/62; H01M 4/02; H01M 4/131; H01M 4/525

(52) U.S. Cl. CPC H01M 4/623; H01M 4/131; H01M 4/525; H01M 2004/021; H01M 2004/028

(57) ABSTRACT

This nonaqueous electrolyte secondary battery positive electrode is characterized by comprising a positive electrode current collector and a positive electrode mixture layer formed on at least one surface of the positive electrode current collector, and is characterized in that: the mass per unit area of the positive electrode mixture layer on the one surface side is 300 g/m² or more; the positive electrode mixture layer has a positive electrode active material and a binder including a fluorine-containing polymer having a weight average molecular weight of 1,000,000 or more; and the positive electrode current collector has a contact angle with respect to N-methyl-2-pyrrolidone of 15-35°, inclusive.

### TECHNICAL FIELD

The present disclosure relates to a non-aqueous electrolyte secondary battery positive electrode and a non-aqueous electrolyte secondary battery.

### BACKGROUND

In recent years, as a secondary battery having a high output and a high energy density, a non-aqueous electrolyte secondary battery has been widely used, in which the non-aqueous electrolyte secondary battery includes a positive electrode, a negative electrode, and a non-aqueous electrolyte, and performs charging and discharging by moving lithium ions and the like between the positive electrode and the negative electrode.

For example, Patent Literature 1 discloses a non-aqueous electrolyte secondary battery characterized by using an aluminum core, the contact angle relative to N-methylpyrrolidone of which is less than or equal to 45°, as a current collector of a positive electrode.

In addition, for example, Patent Literature 2 discloses that a degreased aluminum hard foil is used as a current collector of a positive electrode by subjecting an aluminum foil after foil rolling using kerosene oil as rolling oil to a low-temperature heat treatment in which the aluminum foil is maintained at 80 to 130° C. for one hour or more.

In addition, Patent Literature 3 discloses a non-aqueous electrolyte secondary battery in which polyvinylidene fluoride, the weight average molecular weight of which is greater than or equal to 0.5 million, is used as a binding agent in a positive electrode, and a ratio of the binding agent contained in the positive electrode is in the range of 1.0 to 2.1 mass %.

In addition, Patent Literature 4 discloses a non-aqueous electrolyte secondary battery in which low molecular weight polyvinylidene fluoride, the weight average molecular weight of which is greater than or equal to 0.1 million and less than 0.5 million, and high molecular weight polyvinylidene fluoride, the weight average molecular weight of which is greater than or equal to 0.5 million and less than 1.5 million, are used for a binding agent in a positive electrode.

In addition, Patent Literature 5 discloses a non-aqueous electrolyte secondary battery in which a polyvinylidene fluoride-based resin, the weight average molecular weight of which is greater than or equal to 0.5 million, and polyvinylpyrrolidone are used as a binding agent in a positive electrode.

### CITATION LIST

### Patent Literatures

PATENT LITERATURE 1: JP 2005-50679 A
PATENT LITERATURE 2: JP 2011-134718 A
PATENT LITERATURE 3: JP 2000-260475 A
PATENT LITERATURE 4: JP 2004-079327 A
PATENT LITERATURE 5: JP 2010-123331 A

### SUMMARY

As a means for increasing the capacity of a battery, there is a method of increasing the mass per unit area of a positive electrode mixture layer constituting a positive electrode. However, when an attempt is made to produce the positive electrode including the positive electrode mixture layer having a high mass per unit area, it is difficult to increase the capacity of the battery due to a tailing at an end portion of the positive electrode mixture layer, breakage of a positive electrode current collector, and the like.

An object of the present disclosure is to provide a non-aqueous electrolyte secondary battery positive electrode capable of increasing the capacity of a battery, and a non-aqueous electrolyte secondary battery including the non-aqueous electrolyte secondary battery positive electrode.

A non-aqueous electrolyte secondary battery positive electrode according to one aspect of the present disclosure includes a positive electrode current collector, and a positive electrode mixture layer formed on at least one surface of the positive electrode current collector, in which a mass per unit area of the positive electrode mixture layer on a side of the one surface is greater than or equal to 300 g/m², the positive electrode mixture layer includes a positive electrode active material and a binding agent containing a fluorine-containing polymer, a weight average molecular weight of which is greater than or equal to 1 million, and the positive electrode current collector has a contact angle relative to N-methyl-2-pyrrolidone, the contact angle being greater than or equal to 15° and less than or equal to 35°.

Further, a non-aqueous electrolyte secondary battery according to one aspect of the present disclosure includes the non-aqueous electrolyte secondary battery positive electrode.

According to one aspect of the present disclosure, it is possible to provide a non-aqueous electrolyte secondary battery positive electrode capable of increasing the capacity of a battery, and a non-aqueous electrolyte secondary battery including the non-aqueous electrolyte secondary battery positive electrode.

### BRIEF DESCRIPTION OF DRAWINGS

FIG. 1 is a cross-sectional view of a non-aqueous electrolyte secondary battery as an example of an embodiment.

### DESCRIPTION OF EMBODIMENTS

An example of an embodiment will be described with reference to the drawings. Note that a non-aqueous electrolyte secondary battery of the present disclosure is not limited to the embodiments described below. In addition, the FIGURES referred to in the description of embodiments are schematically illustrated.

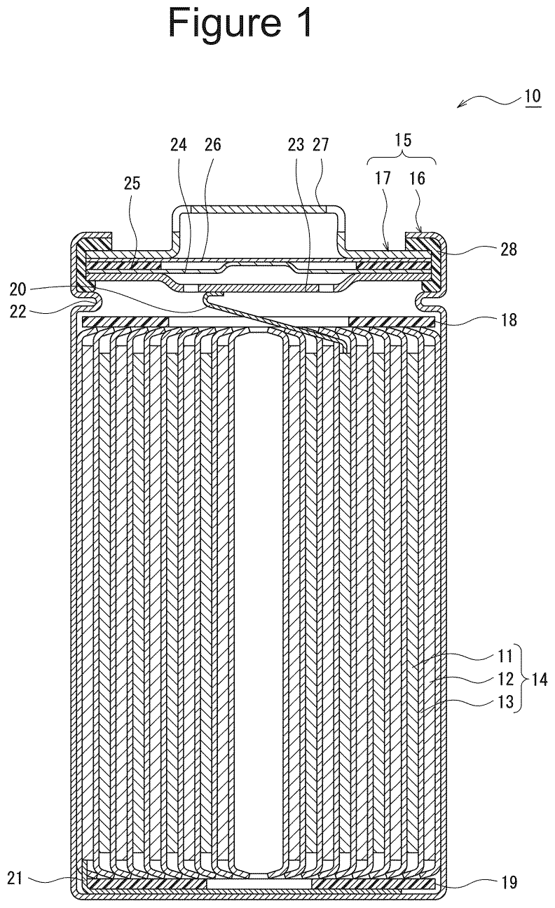

FIG. 1 is a cross-sectional view of a non-aqueous electrolyte secondary battery as an example of an embodiment. A non-aqueous electrolyte secondary battery 10 shown in FIG. 1 includes a winding-type electrode assembly 14 formed by winding a positive electrode 11 and a negative electrode 12 with a separator 13 interposed therebetween, a non-aqueous electrolyte, insulating plates 18 and 19 respectively disposed above and below the electrode assembly 14, and a battery case 15 housing the above-mentioned members. The battery case 15 includes a bottomed cylindrical case body 16 and a sealing assembly 17 that closes an opening of the case body 16. Instead of the winding-type electrode assembly 14, an electrode assembly having another form, such as a stacked electrode assembly in which positive electrodes and negative electrodes are alternately stacked with separators interposed therebetween, may be applied. Examples of the battery case 15 include metallic exterior cans having a cylindrical shape, a square shape, a coin shape, a button shape, or the like, and pouch exterior bodies formed by lamination with a resin sheet and a metal sheet.

The non-aqueous electrolyte includes a non-aqueous solvent and an electrolyte salt dissolved in the non-aqueous solvent. Examples of the non-aqueous solvent include esters, ethers, nitriles, amides, and a mixture of two or more thereof. The non-aqueous solvent may contain a halogen-substituted product in which at least some hydrogen in a solvent described above is substituted with a halogen atom such as fluorine. Examples of the electrolyte salt include lithium salts such as LiPF₆. It is noted that the non-aqueous electrolyte is not limited to the liquid electrolyte, and may be a solid electrolyte using a gel polymer or the like.

The case body 16 is, for example, a bottomed cylindrical metal exterior can. A gasket 28 is provided between the case body 16 and the sealing assembly 17 to ensure the sealing performance inside the battery. The case body 16 has a projecting portion 22 in which, for example, a part of the side part of the case body 16 protrudes inwards to support the sealing assembly 17. The projecting portion 22 is preferably formed in an annular shape in a circumferential direction of the case body 16, and supports the sealing assembly 17 on an upper surface thereof.

The sealing assembly 17 has a structure in which a filter 23, a lower vent member 24, an insulating member 25, an upper vent member 26, and a cap 27 are sequentially stacked from the electrode assembly 14 side. Each member constituting the sealing assembly 17 has, for example, a disk shape or a ring shape, and the members excluding the insulating member 25 are electrically connected to each other. The lower vent member 24 and the upper vent member 26 are connected to each other at the respective center regions, and the insulating member 25 is interposed between the respective peripheral portions. When the internal pressure of the non-aqueous electrolyte secondary battery 10 increases due to heat generated by an internal short circuit or the like, for example, the lower vent member 24 is deformed so as to push the upper vent member 26 up toward the cap 27 side and breaks, and thus the current pathway between the lower vent member 24 and the upper vent member 26 is cut off. When the internal pressure is further increased, the upper vent member 26 is broken, and gas is discharged through the opening of the cap 27.

In the non-aqueous electrolyte secondary battery 10 illustrated in FIG. 1, a positive electrode lead 20 attached to the positive electrode 11 extends through a through-hole of the insulating plate 18 toward a side of the sealing assembly 17, and a negative electrode lead 21 attached to the negative electrode 12 extends through the outside of the insulating plate 19 toward the bottom side of the case body 16. The positive electrode lead 20 is connected to the lower surface of the filter 23, which is the bottom plate of the sealing assembly 17, by welding or the like, and the cap 27, which is electrically connected to the filter 23 and is the top plate of the sealing assembly 17, serves as a positive electrode terminal. The negative electrode lead 21 is connected to a bottom inner surface of the case body 16 by welding or the like, and the case body 16 becomes a negative electrode terminal.

Hereinafter, the positive electrode 11, the negative electrode 12, and the separator 13 will be described in detail.

### [Positive Electrode]

The positive electrode 11 includes a positive electrode current collector and a positive electrode mixture layer formed on at least one surface of the positive electrode current collector. The positive electrode mixture layer may be formed on only one surface or both surfaces of the positive electrode current collector. The positive electrode mixture layer includes a positive electrode active material and a binding agent. The positive electrode mixture layer may contain a conductive agent or the like. The mass per unit area of the positive electrode mixture layer on one side of the positive electrode current collector is greater than or equal to 300 g/m².

The positive electrode 11 is produced, for example, by applying, onto a positive electrode current collector, a positive electrode mixture slurry obtained by adding the positive electrode active material, the binding agent, the conductive agent, and the like in an N-methyl-2-pyrrolidone (hereinafter, referred to as NMP) solvent at a predetermined application amount, drying the positive electrode current collector so as to form a positive electrode mixture layer, and then compressing the positive electrode mixture layer with a compression roller or the like.

As the positive electrode current collector, for example, a metal foil such as an aluminum foil which is stable in a potential range of the positive electrode can be used.

The positive electrode current collector has a contact angle relative to N-methyl-2-pyrrolidone (hereinafter, referred to as NMP), in which the contact angle is greater than or equal to 15° and less than or equal to 35°. Since the positive electrode current collector, the contact angle of which relative to NMP is greater than or equal to 15° and less than or equal to 35°, has good wettability with NMP contained in the positive electrode mixture slurry, even when the positive electrode mixture slurry is applied onto the positive electrode current collector, build-up of the end portion of an application portion is suppressed, and therefore even when the positive electrode mixture layer is compressed by a subsequent compression roller or the like, breakage of the positive electrode current collector is suppressed. The breakage of the positive electrode current collector caused by the build-up of the applied end portion is affected by application mass of the positive electrode mixture slurry. Specifically, when the application mass is set such that the mass per unit area of the positive electrode mixture layer increases, the build-up of the end portion of the application portion increases, and the positive electrode current collector is easily broken. However, in the present embodiment, even when the positive electrode mixture slurry is applied to the positive electrode current collector such that the mass per unit area of the positive electrode mixture layer on one side of the positive electrode current collector is greater than or equal to 300 g/m², the build-up of the end portion of the application portion is suppressed, so that the breakage of the positive electrode current collector caused by the build-up of the end portion of the application portion is also suppressed. Therefore, it is possible to form a positive electrode mixture layer, the mass per unit area of the positive electrode mixture layer on one side of which is greater than or equal to 300 g/m², and the capacity of the battery can be increased.

Usually, oil content such as lubricating oil used in the process of forming the positive electrode current collector into a foil shape remains on the surface of the positive electrode current collector. However, in the present embodiment, a treatment for removing or decomposing an oil content remaining on the surface of the positive electrode current collector is performed. By performing this treatment, the contact angle relative to NMP can be controlled within the above range. Examples of the treatment for removing or decomposing the oil content remaining on the surface of the positive electrode current collector include a heat treatment, a preservation treatment under low humidity conditions, a plasma treatment, and a cleaning treatment of an organic solvent, an acid agent, an alkali agent, or the like. Further, when the positive electrode current collector is an aluminum foil, a boehmite method (a method of forming a film on the surface of the aluminum foil in high-temperature pure water) may be used. Among the treatments, heat treatment is preferable from the viewpoint of processing costs and easy control of the contact angle relative to NMP. The heat treatment is preferably maintained at, for example, 150° C. to 300° C. for one hour or more. In addition, in the case of the preservation treatment under low humidity conditions, for example, it is preferable to perform preservation for one day or more at room temperature and humidity of 50% or less. In the case of the plasma treatment, a well-known plasma treatment apparatus for metal surface treatment or the like may be used. The organic solvent to be used in the cleaning treatment is only required to be able to dissolve NMP, and examples thereof include acetone and the like.

The contact angle relative to NMP is measured as follows. 0.005 cc of N-methyl-2-pyrrolidone (surface tension at 25° C. is 0.41 N/m) is added dropwise to the surface of the positive electrode current collector with a syringe, and the contact angle of the droplet is measured with a contact angle measuring device (DMs-401 manufactured by Kyowa Interface Science Co., Ltd.). The dropping of a test liquid is performed by raising, from below, the positive electrode current collector horizontally disposed relative to the distal end of the syringe disposed in the vertical direction, stopping raising the positive electrode current collector when a liquid end of the test liquid discharged from the syringe is touched without being brought into contact with the syringe, and lowering the positive electrode current collector in about 0.5 seconds.

From the viewpoint of increasing the capacity of the battery, the mass per unit area of the positive electrode mixture layer on one side may be greater than or equal to 300 g/m², but is preferably greater than or equal to 350 g/m². The upper limit of the mass per unit area of the positive electrode mixture layer on one side is preferably less than or equal to 400 g/m² from the viewpoint of drying time, compressibility, and the like of the positive electrode mixture layer.

The positive electrode active material is, for example, a lithium composite oxide capable of reversibly inserting and removing lithium. Examples of the metal element contained in the lithium composite oxide include Ni, Co, Mn, Al, B, Mg, Ti, V, Cr, Fe, Cu, Zn, Ga, Sr, Zr, Nb, In, Sn, Ta, and W. Among the metal elements, it is preferable to contain at least one of Ni, Co, and Mn. An example of a suitable lithium composite oxide is a lithium composite oxide represented by a general formula: LiₓNi_{y}M_{(1-y)}O₂ (in the formula, x and y satisfy 0<x≤1.2 and 0.85≤y≤0.99, and M contains at least one element selected from Co, Al, Mn, Ca, Mg, Sr, Ti, Nb, Zr, Ce, Mo, and W).

The binding agent contains a fluorine-containing polymer, the weight average molecular weight of which is greater than or equal to 1 million. When the fluorine-containing polymer, the weight average molecular weight of which is greater than or equal to 1 million, is contained as the binding agent, it is possible to suppress a tailing formed at the end portion of the application portion at which the positive electrode mixture slurry is applied to the positive electrode current collector. The tailing is a thread trace of the positive electrode mixture slurry formed at the terminal end portion of the application portion when the application of the positive electrode mixture slurry onto the positive electrode current collector is stopped. When the tailing is long, the battery capacity is reduced, but the length of the tailing is affected by the application mass of the positive electrode mixture slurry and the contact angle of the positive electrode current collector relative to NMP. Specifically, the application mass per unit area of the positive electrode mixture slurry is large, and the contact angle of the positive electrode current collector relative to NMP is less than or equal to 35°, so that the length of the tailing is increased. However, in the present embodiment, even if the positive electrode mixture slurry is applied to the positive electrode current collector, the contact angle of which relative to NMP is greater than or equal to 15° and less than or equal to 35° such that the mass per unit area of the positive electrode mixture layer on one side is greater than or equal to 300 g/m², occurrence of a long tailing can be suppressed and, as such, the capacity of the battery can be increased.

The weight average molecular weight of the fluorine-containing polymer may be greater than or equal to 1 million, but is preferably greater than or equal to 1.4 million from the viewpoint of further increasing the capacity of the battery. The upper limit value of the weight average molecular weight of the fluorine-containing polymer is preferably less than or equal to 2 million from the viewpoint of suppressing an increase in viscosity during storage of the positive electrode mixture slurry and the like.

The weight average molecular weight of the fluorine-containing polymer is measured by gel permeation chromatography (GPC). The molecular weight measurement by GPC is performed, for example, using Agilent 1200 manufactured by Agilent Technologies, Inc. as a measuring apparatus, using a 0.45 μm membrane filter, and using a tetrahydrofuran solvent. The weight average molecular weight was calculated from measurement results using a molecular weight calibration curve prepared from a monodisperse polystyrene standard sample.

The fluorine-containing polymer preferably contains, for example, at least one selected from a group formed of a unit derived from vinylidene fluoride (VDF), a unit derived from propylene hexafluoride (HFP), and a unit derived from ethylene tetrafluoride (TFE), in that the fluorine-containing polymer itself has excellent binding properties. Among the units, from the viewpoint of electrochemical stability and the like, the fluorine-containing polymer preferably contains at least the unit derived from VDF. The fluorine-containing polymer containing the unit derived from VDF preferably contains, for example, at least one selected from a group formed of polyvinylidene fluoride (PVDF), a derivative of polyvinylidene fluoride (PVDF), and a copolymer containing the unit derived from vinylidene fluoride (VDF). The copolymer may be, for example, a block copolymer or a random copolymer.

The binding agent may be a fluorine-containing polymer, the weight average molecular weight of which is greater than or equal to 1 million, alone or in combination with another resin. Examples of the resin that can be used in combination include polyacrylonitrile (PAN), a polyimide-based resin, an acryl-based resin, and a polyolefin-based resin.

The fluorine-containing polymer, the weight average molecular weight of which is greater than or equal to 1 million, is contained in the binding agent preferably in a range which is greater than or equal to 50 mass % and less than or equal to 100 mass %, and more preferably in a range which is greater than or equal to 80 mass % and less than or equal to 100 mass %.

A ratio of the binding agent in the positive electrode mixture layer is preferably in a range which is greater than or equal to 0.1 mass % and less than or equal to 7 mass %, and more preferably in a range which is greater than or equal to 0.5 mass % and less than or equal to 5 mass %.

Examples of the conductive agent include carbon-based particles such as carbon black (CB), acetylene black (AB), Ketjenblack, carbon nanotube (CNT), or graphite. These conductive agents may be used alone or in combination of two or more thereof.

### [Negative Electrode]

The negative electrode 12 includes a negative electrode current collector and a negative electrode mixture layer provided on the negative electrode current collector. As the negative electrode current collector, for example, a foil of metal such as copper which is stable in a potential range of the negative electrode is used.

It is preferable that the negative electrode mixture layer contains a negative electrode active material, and preferably further contains a binding agent and the like. The negative electrode 12 can be manufactured by preparing a negative electrode mixture slurry containing the negative electrode active material, the binding agent, and the like, applying the negative electrode mixture slurry onto a negative electrode current collector, performing drying so as to form a negative electrode mixture layer, and compressing the negative electrode mixture layer.

The negative electrode active material is capable of reversibly occluding and releasing a lithium ion, and examples thereof include a carbon material such as natural graphite and artificial graphite, metal alloyed with lithium such as silicon (Si) and tin (Sn), an alloy containing metal elements such as Si and Sn, a composite oxide, and the like.

Examples of the binding agent include a fluorine-based resin, PAN, a polyimide-based resin, an acrylic resin, a polyolefin-based resin, styrene-butadiene rubber (SBR), carboxymethyl cellulose (CMC) or a salt thereof, polyacrylic acid (PAA) or a salt thereof (PAA-Na, PAA-K, and the like, or partially neutralized salt may be used), and polyvinyl alcohol (PVA). These binding agents may be used alone or in combination of two or more thereof. It is noted that the negative electrode mixture layer may contain a conductive agent. The same conductive agent as in the case of the positive electrode 11 can be used.

### [Separator]

As the separator 13, for example, a porous sheet having an ion permeation property and an insulation property is used. Specific examples of the porous sheet include fine porous thin films, woven fabrics, and nonwoven fabrics. As a material of the separator, olefin-based resins such as polyethylene and polypropylene, cellulose, and the like are suitable. The separator 13 may be a stacked body having a cellulose fiber layer and a thermoplastic resin fiber layer such as an olefin-based resin. Further, a multilayer separator including a polyethylene layer and a polypropylene layer may be used, and a separator having a surface coated with a material such as an aramid-based resin or a ceramic may be used.

### Embodiment

Hereinafter, the present disclosure will be further described with reference to embodiments. However, the present disclosure is not limited to these embodiments.

### First Embodiment

### [Manufacture of Positive Electrode]

An aluminum foil (JIS H4160 A8021) having a thickness of 15 μm and a length of 100 m was put in a drying furnace and was subjected to heat treatment at 120° C. for a predetermined time. As a result of measuring the contact angle relative to NMP in the aluminum foil after the heat treatment, it was found to be 15°. The method of measuring the contact angle relative to NMP is as described above.

100 parts by mass of a lithium composite oxide represented by a general formula: LiNi_{0.88}Co_{0.09}Al_{0.03}O₂, 1 part by mass of acetylene black as a conductive agent, and 0.9 parts by mass of polyvinylidene fluoride (PVDF) as a binding agent having a weight average molecular weight of 1.4 million were mixed. The mixture was charged into N-methyl-2-pyrrolidone (NMP) as a dispersion medium and kneaded to prepare a positive electrode mixture slurry.

The positive electrode mixture slurry was intermittently applied to both surfaces of the aluminum foil so as to form a plurality of application portions and non-application portions on the aluminum foil. As application conditions, application mass was set such that the application speed of the positive electrode mixture slurry was 20 m/min and the mass per unit area of the positive electrode mixture layer on one side of the aluminum foil was 300 g/m². The positive electrode mixture slurry was intermittently applied onto the aluminum foil, then dried, and compressed by a constant pressure compression apparatus at a compression linear pressure of 3000 kg/cm, thereby producing a positive electrode in which the positive electrode mixture layer was formed on both surfaces of a positive electrode current collector.

The length (average value) of tailings formed at the plurality of application portions was 2.5 mm. Breakage of the positive electrode current collector did not occur during compression.

The positive electrode produced as described above was cut into a predetermined size and was used as the positive electrode of the first embodiment.

### [Manufacture of Negative Electrode]

93 parts by mass of graphite powder, 7 parts by mass of silicon oxide represented by SiO having a carbon film formed on a particle surface, 1.5 parts by mass of sodium carboxymethylcellulose, and 1 part by mass of styrene-butadiene rubber were mixed, and an appropriate amount of water was added to prepare a negative electrode mixture slurry. The negative electrode mixture slurry was applied onto both surfaces of a copper foil having a thickness of 8 μm, a coating film was dried, and then the dried coating film was compressed by a compression roller, thereby manufacturing a negative electrode in which a negative electrode mixture layer was formed on both surfaces of a negative electrode current collector. The negative electrode was cut into a predetermined size so as to be used.

### [Preparation of Non-Aqueous Electrolyte]

5 parts by mass of vinylene carbonate (VC) was added to 100 parts by mass (EC:DMC=1:3 by volume) of a mixed solvent formed of ethylene carbonate (EC) and dimethyl carbonate (DMC), and LiPF₆ was dissolved at a concentration of 1 mol/L. The resulting mixture was used as a non-aqueous electrolyte.

### [Manufacture of Secondary Battery]

(1) A lead was attached to each of the positive electrode and the negative electrode, and then the lead was wound between the positive electrode and the negative electrode with a separator made of polyethylene having a thickness of 20 μm interposed therebetween, thereby producing a wound-type electrode assembly.
(2) The electrode assembly was inserted into a case body, the lead on the negative electrode side was welded to the bottom of the case body, and the lead on the positive electrode side was welded to a sealing assembly.
(3) A non-aqueous electrolyte was injected into the case body, and then an end portion of an opening of the case body was caulked with the sealing assembly via a gasket. This was used as a non-aqueous electrolyte secondary battery.

### Second Embodiment

The positive electrode was produced in the same manner as in the first embodiment, except that the aluminum foil was produced in such a manner that the heat treatment time of the aluminum foil was made shorter than that in the first embodiment and the contact angle relative to NMP was adjusted to 35°. In this positive electrode, the length (average value) of the tailings formed at the plurality of application portions was 1.8 mm, and breakage of the positive electrode current collector due to compression did not occur. Then, the non-aqueous electrolyte secondary battery was produced in the same manner as in the first embodiment, except that this positive electrode was cut into a predetermined size and was used as the positive electrode of the second embodiment.

### Third Embodiment

The positive electrode was produced in the same manner as in the first embodiment, except that the application mass was set such that the mass per unit area of the positive electrode mixture layer on one side was 350 g/m² as application conditions of the positive electrode mixture slurry. In this positive electrode, the length (average value) of the tailings formed at the plurality of application portions was 3.0 mm, and breakage of the positive electrode current collector due to compression did not occur. Then, the non-aqueous electrolyte secondary battery was produced in the same manner as in the first embodiment, except that this positive electrode was cut into a predetermined size and was used as the positive electrode of the third embodiment.

### Fourth Embodiment

The positive electrode was produced in the same manner as in the third embodiment, except that the aluminum foil was produced in such a manner that the heat treatment time of the aluminum foil was made shorter than that in the first embodiment and the contact angle relative to NMP was adjusted to 25°. In this positive electrode, the length (average value) of the tailings formed at the plurality of application portions was 2.8 mm, and breakage of the positive electrode current collector due to compression did not occur. Then, the non-aqueous electrolyte secondary battery was produced in the same manner as in the first embodiment, except that this positive electrode was cut into a predetermined size and was used as the positive electrode of the fourth embodiment.

### Fifth Embodiment

The positive electrode was produced in the same manner as in the third embodiment, except that the aluminum foil produced in the second embodiment was used. In this positive electrode, the length (average value) of the tailings formed at the plurality of application portions was 2.5 mm, and breakage of the positive electrode current collector due to compression did not occur. Then, the non-aqueous electrolyte secondary battery was produced in the same manner as in the first embodiment, except that this positive electrode was cut into a predetermined size and was used as the positive electrode of the fifth embodiment.

### Sixth Embodiment

The positive electrode was produced in the same manner as in the first embodiment, except that polyvinylidene fluoride (PVDF) having a weight average molecular weight of 1.2 million was used. In this positive electrode, the length (average value) of the tailings formed at the plurality of application portions was 2.9 mm, and breakage of the positive electrode current collector due to compression did not occur. Then, the non-aqueous electrolyte secondary battery was produced in the same manner as in the first embodiment, except that this positive electrode was cut into a predetermined size and was used as the positive electrode of the sixth embodiment.

### Seventh Embodiment

A positive electrode was produced in the same manner as in the second embodiment, except that polyvinylidene fluoride (PVDF) having a weight average molecular weight of 1.2 million was used. In this positive electrode, the length (average value) of the tailings formed at the plurality of application portions was 2.3 mm, and breakage of the positive electrode current collector due to compression did not occur. Then, the non-aqueous electrolyte secondary battery was produced in the same manner as in the first embodiment, except that this positive electrode was cut into a predetermined size and was used as the positive electrode of the seventh embodiment.

### First Comparative Example

An attempt was made to produce the positive electrode in the same manner as in the first embodiment, except that an aluminum foil was produced in such a manner that the heat treatment time of the aluminum foil was made shorter than that in the first embodiment, and the contact angle relative to NMP was adjusted to 40°, and polyvinylidene fluoride (PVDF) having a weight average molecular weight of 1.2 million was used. As a result, breakage of the positive electrode current collector occurred, and therefore the non-aqueous electrolyte secondary battery could not be produced. In this positive electrode, the length (average value) of the tailings formed at the plurality of application portions was 2.0 mm.

### Second Comparative Example

An attempt was made to produce a positive electrode in the same manner as in the first embodiment, except that an aluminum foil was produced in such a manner that the heat treatment time of the aluminum foil was made shorter than that in the first embodiment, and the contact angle relative to NMP was adjusted to 45°, and polyvinylidene fluoride (PVDF) having a weight average molecular weight of 0.4 million was used. As a result, breakage of the positive electrode current collector occurred, and therefore the non-aqueous electrolyte secondary battery could not be produced. In this positive electrode, the length (average value) of the tailings formed at the plurality of application portions was 2.5 mm.

### Third Comparative Example

The positive electrode was produced in the same manner as in the first embodiment, except that an aluminum foil was produced in such a manner that the heat treatment time of the aluminum foil was made shorter than that in the first embodiment and the contact angle relative to NMP was adjusted to 20°, and polyvinylidene fluoride (PVDF) having a weight average molecular weight of 0.4 million was used. In this positive electrode, the length (average value) of the tailings formed at the plurality of application portions was 5.5 mm, and breakage of the positive electrode current collector due to compression did not occur. Then, the non-aqueous electrolyte secondary battery was produced in the same manner as in the first embodiment, except that this positive electrode was cut into a predetermined size and was used as the positive electrode of the third comparative example.

### Fourth Comparative Example

The positive electrode was produced in the same manner as in the first embodiment, except that an aluminum foil was produced in such a manner that the heat treatment time of the aluminum foil was made shorter than that in the first embodiment and the contact angle relative to NMP was adjusted to 30°, and polyvinylidene fluoride (PVDF) having a weight average molecular weight of 0.5 million was used. In this positive electrode, the length (average value) of the tailings formed at the plurality of application portions was 4.0 mm, and breakage of the positive electrode current collector due to compression did not occur. Then, the non-aqueous electrolyte secondary battery was produced in the same manner as in the first embodiment, except that this positive electrode was cut into a predetermined size and was used as the positive electrode of the fourth comparative example.

### Fifth Comparative Example

The positive electrode was produced in the same manner as in the fifth embodiment, except that polyvinylidene fluoride (PVDF) having a weight average molecular weight of 0.9 million was used. In this positive electrode, the length (average value) of the tailings formed at the plurality of application portions was 4.3 mm, and breakage of the positive electrode current collector due to compression did not occur. Then, the non-aqueous electrolyte secondary battery was produced in the same manner as in the first embodiment, except that this positive electrode was cut into a predetermined size and was used as the positive electrode of the fifth comparative example.

### Sixth Comparative Example

The positive electrode was produced in the same manner as in the first embodiment, except that the application mass was set such that the mass per unit area of the positive electrode mixture layer on one side was 250 g/m² as application conditions of the positive electrode mixture slurry. In this positive electrode, the length (average value) of the tailings formed at the plurality of application portions was 1.5 mm, and breakage of a positive electrode current collector due to compression did not occur. Then, a non-aqueous electrolyte secondary battery was produced in the same manner as in the first embodiment, except that this positive electrode was cut into a predetermined size and was used as the positive electrode of the sixth comparative example.

### Seventh Comparative Example

The positive electrode was produced in the same manner as in the sixth comparative example, except that the aluminum foil of the second comparative example was used and polyvinylidene fluoride (PVDF) having a weight average molecular weight of 0.5 million was used. In this positive electrode, the length (average value) of the tailings formed at the plurality of application portions was 1.6 mm, and breakage of the positive electrode current collector due to compression did not occur. Then, the non-aqueous electrolyte secondary battery was produced in the same manner as in the first embodiment, except that this positive electrode was cut into a predetermined size and was used as the positive electrode of the seventh comparative example.

Table 1 summarizes presence or absence of breakage of the positive electrode current collector and the length of the tailing of the application portion in each of the embodiments and the comparative examples.

TABLE 1

| | Positive electrode mixture | | | | |
|---|---|---|---|---|---|
| | layer | | | Evaluation | |
| | | PVDF weight | Positive electrode | Positive electrode | |
| | | average | current collector | current collector | |
| | Base weight | molecular | NMP contact | breakage: | Tailing |
| | (g/m²) | weight | angle (°) | presence/absence | (mm) |
| First | 300 | 1.4 million | 15 | Absence | 2.5 |
| embodiment | | | | | |
| Second | 300 | 1.4 million | 35 | Absence | 1.8 |
| embodiment | | | | | |
| Third | 350 | 1.4 million | 15 | Absence | 3.0 |
| embodiment | | | | | |
| Fourth | 350 | 1.4 million | 25 | Absence | 2.8 |
| embodiment | | | | | |
| Fifth | 350 | 1.4 million | 35 | Absence | 2.5 |
| embodiment | | | | | |
| Sixth | 300 | 1.2 million | 15 | Absence | 2.9 |
| embodiment | | | | | |
| Seventh | 300 | 1.2 million | 35 | Absence | 2.3 |
| embodiment | | | | | |
| First | 300 | 1.2 million | 40 | Presence | 2.0 |
| Comparative | | | | | |
| Example | | | | | |
| Second | 300 | 0.4 million | 45 | Presence | 2.5 |
| Comparative | | | | | |
| Example | | | | | |
| Third | 300 | 0.4 million | 20 | Absence | 5.5 |
| Comparative | | | | | |
| Example | | | | | |
| Fourth | 300 | 0.5 million | 30 | Absence | 4.0 |
| Comparative | | | | | |
| Example | | | | | |
| Fifth | 350 | 0.9 million | 35 | Absence | 4.3 |
| Comparative | | | | | |
| Example | | | | | |
| Sixth | 250 | 1.4 million | 25 | Absence | 1.5 |
| Comparative | | | | | |
| Example | | | | | |
| Seventh | 250 | 0.5 million | 45 | Absence | 1.6 |
| Comparative | | | | | |
| Example | | | | | |

### [Charge/Discharge Test]

The non-aqueous electrolyte secondary battery of each embodiment and each comparative examples was subjected to constant current charge at a current of 1.0 C under a temperature environment of 25° C. until a voltage reached 4.2 V. and then subjected to constant voltage charge at a voltage of 4.2 V until a current reached 1/50C. Then, constant current discharge was performed at a current of 0.2C until a voltage reached 2.5 V. The discharge capacity at this time was measured as a battery capacity.

The first, second, sixth, and seventh embodiments in which the mass per unit area of the positive electrode mixture layer on one side was 300 g/m² showed higher battery capacity than that in the third and fourth comparative examples in which the mass of the positive electrode mixture layer was the same. This is considered to be because the lengths of the tailings in the first, second, sixth, and seventh embodiments were shorter than those in the third and fourth comparative examples. In the third, fourth, and fifth embodiments in which the mass per unit area of the positive electrode mixture layer on one surface side was 350 g/m², the battery capacity was higher than that in the fifth comparative examples having the same base weight. This is also considered to be because in the third, fourth, and fifth embodiments, the length of the tailing was shorter than that in the fifth comparative example. It is noted that, in the first and second comparative examples, the non-aqueous electrolyte secondary battery could not be produced due to breakage of the positive electrode current collector. Further, in the sixth and seventh comparative examples, the length of the tailing was short, and the positive electrode current collector was not broken, but the mass per unit area of the positive electrode mixture layer on one side was 250 g/m², which was lower than that in the embodiment, and thus the battery capacity was lower than that in the embodiment. From these results, the capacity of the battery can be increased by using a positive electrode in which the mass per unit area of the positive electrode mixture layer on one side of the positive electrode current collector is greater than or equal to 300 g/m², the positive electrode mixture layer has the positive electrode active material and the binding agent containing the fluorine-containing polymer, the weight average molecular weight of which is greater than or equal to 1 million, and the contact angle relative to N-methyl-2-pyrrolidone is greater than or equal to 15° and less than or equal to 35°.

### REFERENCE SIGNS LIST

10 NON-AQUEOUS ELECTROLYTE SECONDARY BATTERY
11 POSITIVE ELECTRODE
12 NEGATIVE ELECTRODE
13 SEPARATOR
14 ELECTRODE ASSEMBLY
15 BATTERY CASE
16 CASE BODY
17 SEALING ASSEMBLY
18, 19 INSULATING PLATE
20 POSITIVE ELECTRODE LEAD
21 NEGATIVE ELECTRODE LEAD
22 PROJECTING PORTION
23 FILTER
24 LOWER VENT MEMBER
25 INSULATING MEMBER
26 UPPER VENT MEMBER
27 CAP
28 GASKET

1. A non-aqueous electrolyte secondary battery positive electrode comprising: a positive electrode current collector; and a positive electrode mixture layer formed on at least one surface of the positive electrode current collector, wherein:
a mass per unit area of the positive electrode mixture layer on a side of the one surface is greater than or equal to 300 g/m²,
the positive electrode mixture layer includes a positive electrode active material and a binding agent containing a fluorine-containing polymer, a weight average molecular weight of which is greater than or equal to 1 million, and
the positive electrode current collector has a contact angle relative to N-methyl-2-pyrrolidone, the contact angle being greater than or equal to 15° and less than or equal to 35°.

2. The non-aqueous electrolyte secondary battery positive electrode according to claim 1, wherein the positive electrode active material contains a lithium composite oxide represented by a general formula: LiₓNi_{y}M_{(1-y)}O₂ (in the formula, x and y satisfy 0<x≤1.2 and 0.85≤y≤0.99, and M contains at least one element selected from Co, Al, Mn, Ca, Mg, Sr, Ti, Nb, Zr, Ce, Mo, and W).

3. The non-aqueous electrolyte secondary battery positive electrode according to claim 1, wherein the weight average molecular weight of the fluorine-containing polymer is greater than or equal to 1.4 million.

4. A non-aqueous electrolyte secondary battery comprising the non-aqueous electrolyte secondary battery positive electrode according to claim 1.
